(19) United States
(12) Patent Application Publication
(10) Pub. No.: US 2014/0272804 A1
(43) Pub. Date: Sep. 18, 2014

(54) COMPUTER ASSISTED TRAINING SYSTEM FOR INTERVIEW-BASED INFORMATION GATHERING AND ASSESSMENT

(71) Applicant: Her Majesty the Queen in Right of Canada, as represented by the Minster of National Defence, (US)

(72) Inventors: Ming HOU, North York (CA); Simon BANBURY, Quebec (CA); Michael LEPARD, Ottawa (CA)

(73) Assignee: Her Majesty the Queen in Right of Canada, as represented by the Minster of National Defence, Ottawa (CA)

(21) Appl. No.: 13/827,694

(22) Filed: Mar. 14, 2013

(51) Int. Cl. G09B 5/02

(52) U.S. Cl. CPC G09B 5/02
USPC 434/11

(57) ABSTRACT

A computer-assisted training system for interview-based information gathering and assessment. A GUI displays information pertaining to a training scenario and generates event messages based on student input. An Evaluation Engine compares event messages to rules embodying predetermined instructional content and generates evaluation comments. An Adaptation Engine processes the evaluation comments to produce student feedback that is presented to the student via the GUI. The training scenario includes a scene defining a physical context of the scenario; one or more witnesses who may be interviewed by the student; and the predetermined instructional content. The instructional content includes any of: a predetermined line of questions to be posed by the student to elicit clues relevant to a particular subject of the training scenario, preferred questioning techniques to be employed by the student; and a predetermined line of reasoning to be employed by the student to deduce characteristics of the particular subject.

### CROSS-REFERENCE TO RELATED APPLICATIONS

This is the first application filed in respect of the present invention.

### FIELD OF THE INVENTION

The present application relates generally to computer-assisted training systems, and more specifically to a computer-assisted training system for developing interview-based information gathering and assessment skills.

### BACKGROUND

Computer-assisted training systems are known in the art, for providing trainees with enhanced opportunities to develop their skills in a specific area. Software of this type is increasingly being used to provide specialized training for law-enforcement and military personnel.

Hays, et al.; Assessing Learning from a Mixed-Media, Mobile Counter-IED Trainer; Interservice/Industry Training, Simulation, and Education Conference (I/ITSEC) 2011, paper 11058, describes a computer assisted counter-Improvised Explosive Device (IED) training system referred to as ExCITE, intended to teach military personnel to counter the threat of IEDs. Some of the training modules introduce the trainee to physical clues in an environment and/or behavioral clues of persons that may indicate the presence of an IED.

Pettitt, et al. Recognition of Combatants-Improvised Explosive Devices (ROC-IED) Training Effectiveness Evaluation; Aberdeen Research Laboratory; (March 2009) describes a computer-assisted training system intended to teach military personnel to recognise behavioral clues that may indicate a covert enemy combatant and/or an IED.

Both of the above systems teach the trainee to identify physical clues in the environment, and behavioral clues of various persons to detect various threats. However, neither system provides training in interview techniques. In particular, neither system provides training in how to conduct an interview of a person to glean clues regarding IEDs or other threats.

U.S. Pat. No. 5,597,312 (Bloom et al.) describes a computer-assisted training system for teaching Customer Service Representatives (CSRs) to handle customer calls regarding a particular service or product, and initiate appropriate work orders. A component of the training involves teaching the CSR to obtain relevant information from a customer so as to categorize the call and select an appropriate response from among a set of predetermined responses. However, in the context of customer calls, it can be assumed that the customer wants to provide relevant information to the CSR. In this case, the CSR's task is simply a matter of recognising what the customer wants to accomplish, and selecting an appropriate response.

In many situations, it may be necessary to gather information about a particular subject by interviewing a witness. For example, military personnel are frequently faced with the challenge of interviewing people in order to identify, recognize, and formulate an accurate threat assessment of a suspected IED or other threat. The effective questioning of such witnesses by military personnel to determine key information elements (or clues) about a threat such as an IED is considered to be both one of the most critical aspects of formulating an accurate threat assessment, and one of the most difficult skills to train.

Similar situations are encountered in other industries. For example, medical professionals frequently must attempt to determine important information about a patient's medical condition by questioning the patient and/or family members. Similarly, police officers are frequently required to interview witnesses and/or suspects in an effort to obtain information relevant to a criminal investigation.

What is needed is a computer-assisted training system for interview-based information gathering that enables an interviewer to identify, recognize, and formulate an accurate assessment of a particular subject.

### SUMMARY

An aspect of the present invention provides a computer-assisted training system for interview-based information gathering and assessment. A (Graphical User Interface) GUI displays information pertaining to a training scenario and generates event messages based on student input. An Evaluation Engine compares event messages to a rule set embodying predetermined instructional content and generates evaluation comments. An Adaptation Engine processes the evaluation comments to produce student feedback that is presented to the student via the GUI. The training scenario includes a scene defining a physical context of the scenario; a set of one or more witnesses who may be interviewed by the student; and the predetermined instructional content. The instructional content includes any of: a predetermined line of questions to be posed by the student to elicit clues relevant to a particular subject of the training scenario, preferred questioning techniques to be employed by the student; and a predetermined line of reasoning to be employed by the student to deduce characteristics of the particular subject.

### BRIEF DESCRIPTION OF THE DRAWINGS

Further features and advantages of the present invention will become apparent from the following detailed description, taken in combination with the appended drawings, in which:

FIG. 1 is a block diagram schematically illustrating elements and operation of a system in accordance with a representative embodiment;

FIG. 2 schematically illustrates a display screen of an example GUI usable in the system of FIG. 1;

FIG. 3 shows an example student feed-back window;

FIG. 4 shows an example Clue Classification Feedback window;

FIG. 5 shows an example Overall Threat Assessment Feedback window; and

FIG. 6 shows a table of representative evaluation criteria and instructional interventions.

It will be noted that throughout the appended drawings, like features are identified by like reference numerals.

### DETAILED DESCRIPTION

Disclosed is a computer assisted training system for interview-based information gathering that enables an interviewer to identify, recognize, and formulate an accurate assessment of a particular subject. The particular subject can comprise a threat, for example an explosive device. In the present description, aspects of the present invention are illustrated by way of example embodiments in which the particular subject is a suspected Improvised Explosive Device (IED), and the goal of the interviewer is to identify, recognise and formulate an accurate threat assessment of that suspected IED. However, it will be recognised that such embodiments are not limitative of the present invention. Indeed, techniques and systems in accordance with the present invention may be used in any industry or context where it is desired to train personnel to interview one or more witnesses in order to identify, recognize, and formulate an accurate assessment of a particular subject, independently of what that particular subject happens to be.

In general, the present invention provides a computer assisted training system in which interview-based information gathering and assessment skills are taught to the student by means of one or more training scenarios. Preferably, a scenario comprises: a scene defining the physical context of the scenario; a set of one or more witnesses who may be interviewed to obtain clues relevant to the particular subject of the scenario; and instructional content.

In general, the scene sets out the physical context of the scenario, and anything within that context that may be relevant to the scenario. For example, the scene may comprise an office suite in a building, in which an IED may be present. In some embodiments, the scene may be presented to the student by means of one or more images, videos, a virtual reality environment, or any other suitable technique. In some embodiments, the scene may also include “physical” clues which the student may be required to interpret. For example, an office scene may include graffiti on a wall, or a damaged access door. In some embodiments, the student may be able to move around within the scene, or view different parts of the scene in response to input via a keyboard, mouse, or other pointer device, for example.

In some embodiments, witnesses may be presented to the student by means of one or more images, videos, avatars in a virtual reality environment, or any other suitable technique. In some embodiments, a witness may appear as a character within a visual representation of the scene. In some embodiments, one or more witnesses may be controlled by means of an artificial intelligence or the like, in accordance with the parameters of the scenario. In some embodiments, one or more witnesses may be controlled by a human such as another student or a tutor.

In general terms, the instructional content defines the subject matter that the student is expected to review and/or learn in the course of working through the scenario. In some embodiments, the instructional content defines at least one line of questioning that has been previously designed to elicit useful information about the particular subject of the scenario. In some embodiments, the instructional content defines at least one line of reasoning for interpreting clues and arriving at appropriate deductions regarding the particular subject of the scenario. For example, the instructional content may define a line of reasoning by which the student may deduce the most likely type of IED based on both physical clues visible in the scene and clues provided by witnesses. In some embodiments, the instruction content may also define one or more constraints under which the student must operate. For example, the student may be required to complete the training scenario with a predetermined period of time.

It is contemplated that a student may work their way through a training scenario by posing questions to each witness, observing the scene, and using the clues so obtained to deduce the most likely type of IED and assess the threat posed by it. The student may be provided with real-time feedback regarding the questions they have posed to each witness and their evolving assessment of the suspected IED and the threat. In some embodiments, Intelligent Tutoring System (ITS) technology known in the art may be used to facilitate real-time evaluation of student performance and feedback, including provision of tutor's comments and hints to assist the student. By comparing student performance (based, for example, on current and past question selection) against a predetermined rule set of preferred questioning techniques, an ITS tutor may generate evaluation comments as real-time feedback on the student's question selection and clue classification to improve student questioning efficiency and overall training effectiveness.

FIG. 1 schematically illustrates representative elements of a system implementing the present technique to generate student feedback during execution of a training scenario. In the embodiment of FIG. 1, the system comprises a Graphical User Interface (GUI) 2, an Evaluation Engine 4 and an Adaptation Engine 6.

The GUI 2 may be provided as any suitable combination of hardware and software and is configured to display information pertaining to the training scenario and receive input from the student. Student input 8 may take any suitable form including (but not limited to) mouse or pointer clicks, responses to Feedback tips or queries, and questions to be posed to witnesses within the scene. Each student input, of any form, may trigger a corresponding Event Message 10 which is supplied to the Evaluation Engine 4. The Evaluation Engine 4 may compare Event Messages to a predetermined rule set embodying the instructional content of the training scenario and output Evaluation Comments 12 to the Adaptation Engine. The Evaluation Comments 12 reflects the real-time performance of the student. Then the Adaptation Engine 6 may process the Evaluation Comments to produce student feedback 14 that is presented to the student via the GUI 2.

FIG. 2 is a schematic illustration of a representative screen display of a GUI that may be used in embodiments of the present invention. In the embodiment of FIG. 2, the screen display is divided into a Scene View 16, a Dialogue Window 18, and a Question Area 20. The Scene View 16 provides a visual representation of the scene defined in the training scenario. In some embodiments, the Scene View 16 also enables the student to interact with the scenario, for example by selecting a witness to question, navigate to one or more areas within the scene, and investigate a suspected IED to reveal visual clues. As noted above, any suitable visualization technique may be used, including, but not limited to: still images, videos, virtual reality etc. If desired, the Scene View 16 may also include means enabling the student to select different images or points of view, for example by moving around within a virtual reality space. The Dialogue Window 18 provides a record of the trainee's interviews with each witness, the trainee's assessment of the clues obtained during the course of the training scenario, and their deductions regarding the IED. In some embodiments, the Dialogue Window 18 may display a history of communication between the student and the intelligent tutor, an image 22 identifying a current witness, a current answer 24, as well as past answers and instructional feedback. The Dialogue Window may also provide a means for the student to communicate with an instructor or tutor, analyse clues and assess the particular subject of the training scenario. In some embodiments, the Dialogue Window 18 may be divided into two or more sections, each of which may be accessed by selecting a respective tab 26. In the illustrated embodiment, a set of two tabs are shown, but more or fewer tabs may be provided as required by the training scenario. A first tab may provide a Dialogue History, which may be used to display all questions and answers as well as instructional feedback provided by the intelligent tutor. A second tab may provide a “Threat Assessment” area. When this tab is selected, all clues identified to that time and how the student classified them are displayed. The student can then compare his/her assessment with the correct assessment provided by the tutor. In some embodiments, the Dialogue Window 18 may also provide the student with some means for requesting feedback, hints or tips, and more details from the instructor. In the illustrated embodiment, this function is provided by an “Ask More Details” button 28, although any other suitable technique may be used if desired. The detailed information can be provided in any suitable format including verbal and visual (text, photo, or video) formats. The Question Area 20 enables the student to select questions to ask a witness and may be divided into multiple columns. In the illustrated embodiment, five columns are shown, although more or fewer columns may be provided as desired. A question type t column 30 (on the left of FIG. 2) shows five interrogative question types: who, what, where, when, and why. When the trainee selects a question type, a set of questions of that type can be displayed in one or more follow-up question columns 32-40. When the student selects a question, it is displayed in the Dialogue Window 18 as the current question, and a set of follow-up questions may be displayed in one or more of the columns 32-40 to the right. When a question is selected by the trainee and asked to a witness, the Dialogue Window 18 may be updated to reflect the question asked and its associated answer from the witness, which will appear in both areas of Current Answer and Dialogue Window. An interview session can be ended by selection of “Goodbye” in the question type column 30.

In general, a training scenario may comprise any desired number of witnesses. The GUI must provide means by which the student can pose questions to each witness, and receive their answers. In the illustrated embodiment, this is accomplished by means of a selection of a witness in the Scene View. In image of the selected witness may then appear in Dialogue Window. The student can engage in a text chat session with the respective witness by selecting question types in the left column and the follow-on questions in the Question Area. This arrangement is convenient, in that it enables the student to engage in multiple different interview sessions by selecting different types of questions towards efficiently achieving the goal of situation assessment. However, this is not essential. Any suitable means of interviewing each witness, and organizing the content of each interview, may be used. Preferably, the GUI provides a means by which the student can identify each witness, and associate that witness with their respective question set. In the illustrated embodiment, this is accomplished by means of image tiles, each of which may contain an image (or other identifier) of a respective one of the witnesses. An image tile 22 of the Current Witness may be positioned on the GUI in an area provided for that purpose, as shown in FIG. 2.

The Evaluation Engine 4 may be provided as any suitable combination of hardware and software and is configured to compare event messages to a predetermined rule set embodying the instructional content of the training scenario and generate evaluation comments that reflect the real-time performance of the student. As noted above, the rule set may be based on predetermined lines of questions to be posed to witnesses, preferred questioning techniques to be employed by the student, and lines of reasoning to be employed by the student to deduce the type of IED and assess the threat posed by the IED. As the student works their way through the training scenario, a corresponding stream of event messages representative of the student's input are received and processed by the Evaluation Engine, which builds an historical record of both student input, and evaluation comments. Newly received messages and the historical record can be compared to the rule set, and logical inference use to generate new Evaluation Comments that reflect both the current performance of the student and their progress in learning the instructional content of the training scenario.

The Adaptation Engine 6 may be provided as any suitable combination of hardware and software and is configured to process the evaluation comments from the Evaluation Engine to produce student feedback that is presented to the student via the GUI. In some embodiments, the Adaptation Engine may access a database of predetermined feedback content using the received evaluation comment, in order to identify a set of applicable feedback items. From these items, the Adaptation Engine may select one or more of the identified feedback items, for presentation to the student, based on the student's learning style and past performance history. By this means, the student may be presented with feedback that is tailored to their needs, which tends to maximize their opportunity to learn the instructional content of the training scenario.

The following description illustrates an example training scenario utilizing the system of FIGS. 1 and 2. The illustrated training scenario is designed for training a student's questioning techniques and interview skills for use when they are at a scene and under temporal pressure to assess the situation and identify clues for different types of IEDs. The scenario simulates a domestic IED threat, and requires the student to question a number of witnesses in order to reveal and identify clues that support or refute a deduction that the IED type is time-initiated, remotely-detonated/command, or victim-operated. The questions are designed to determine the “who, what, when, where, and why” about the IED and are based on predetermined lines of questioning. Known Intelligent Tutoring System (ITS) technology is used to provide helpful real-time feedback on the student's questioning technique in the form of short tips highlighting instances of good or poor questioning techniques. The students are assessed based on their ability to ask good questions and deduce the correct device type from the revealed clues. The main software components used in the training scenario include a graphical user interface, an evaluation engine, and an adaptation engine, as illustrated in FIG. 1. The evaluation engine compares student performance (based on current and past question selection) against a rule set and generates evaluation comments. Then, the adaptation engine matches the evaluation comments to instructional content which appears on-screen as real-time feedback from the embedded intelligent tutor.

Feedback to the student can be presented in four ways, as described below.

Individual Question Feedback. Based on the type of question posed by the student, the tutor may provide immediate feedback on whether the question was good or poor. I some cases, this feedback may also include the specific question (and witness answer) that triggered the tutor's response. An example Individual Question Feedback window is shown in FIG. 3.

Individual Clue Classification Feedback. As the student questions a witness, each clue that has been revealed as a result of the dialogue must be classified as either supporting or refuting a Timed (T), Command (C), or Victim-operated (V) device, or none of the above (Not Applicable—N/A). Based on this threat assessment, the tutor provides feedback on whether the threat assessment was correct or not, together with a rationale for the correct response specific to each clue. An example Clue Classification Feedback window, which may be presented once the student has completed an interview with a witness and assessed the clues obtained, is illustrated in FIG. 4.

Overall Threat Assessment Feedback. Immediately after the student has completed the final assessment of the device (which effectively finishes the training scenario), a scenario debrief is presented. The debriefing comprises a summary of the scenario's back-story, target, device type, and the critical clues that contributed to that assessment. An example Overall Threat Assessment Feedback window, which may be presented once the student has completed the Training scenario, is illustrated in FIG. 5.

Overall Questioning Technique Feedback. After the tutor provides feedback on the student's final threat assessment, a series of training modules pertaining to instructional interventions by the tutor during the training scenario are presented. FIG. 6 is a table showing representative evaluation criteria and instructional interventions. Any instance of tutor feedback during the game will trigger that specific module to be presented on the game's completion. Therefore, the presentation of modules is determined by the questioning performance of the student. Finally, each training module also includes the question (and answer) that triggered the tutor's response.

The embodiments of the invention described above are intended to be illustrative only. The scope of the invention is therefore intended to be limited solely by the scope of the appended claims.

We claim:

1. A system for computer-assisted training of interview-based information gathering and assessment, the system comprising:
a Graphical User Interface (GUI) configured to display information pertaining to a predetermined training scenario and generate event messages based on input received from a student;
an Evaluation Engine configured to compare event messages to a rule set embodying predetermined instructional content of a training scenario and to generate evaluation comments that reflect a real-time performance of the student; and
an Adaptation Engine configured to process the evaluation comments from the Evaluation Engine to produce student feedback that is presented to the student via the GUI;
wherein the training scenario comprises: a scene defining a physical context of the scenario; a set of one or more witnesses who may be interviewed by the student to obtain clues as to a particular subject of the scenario; and the predetermined instructional content; and
wherein the predetermined instructional content comprises any one or more of:
a predetermined line of questions to be posed by the student to elicit clues relevant to the particular subject of the training scenario,
preferred questioning techniques to be employed by the student; and
a predetermined line of reasoning to be employed by the student to deduce characteristics of the particular subject.

2. The system of claim 1, wherein the scene comprises at least one visible clue, and wherein the predetermined line of reasoning includes recognition and assessment of each visible clue.

3. The system of claim 1 wherein the Evaluation Engine is configured to generate a current evaluation message by comparing a current event message and an historical record of past event messages and evaluation comments to the predetermined rule set.

4. The system of claim 1 wherein the Adaptation Engine is configured to:
access a database of predetermined feedback content, using an evaluation comment, to identify a set of applicable feedback items; and
select one or more of the identified feedback items for presentation to the student, based on the student's learning style and past performance history.

5. The system of claim 1 wherein the particular subject comprises an improvised explosive device.

6. A method of computer-assisted training of interview-based information gathering and assessment, the system comprising:
defining a training scenario including a scene defining a physical context of the scenario; a set of one or more witnesses who may be interviewed to obtain clues as to a particular subject of the training scenario; and instructional content defining subject matter to be learned by the student;
presenting information of the training scenario to a student using a Graphical User Interface (GUI);
processing student input using an evaluation engine to generate evaluation comments;
processing the evaluation comments to generate student feedback; and
presenting the student feedback to the student via the GUI;
wherein the predetermined instructional content comprises any one or more of:
a predetermined line of questions to be posed by the student to elicit clues relevant to the particular subject of the training scenario,
preferred questioning techniques to be employed by the student; and
a predetermined line of reasoning to be employed by the student to deduce characteristics of the particular subject.

7. The method of claim 6, wherein the scene comprises at least one visible clue, and wherein the predetermined line of reasoning includes recognition and assessment of each visible clue.

8. The method of claim 6 wherein the Evaluation Engine is configured to generate a current evaluation message by comparing a current event message and an historical record of past event messages and evaluation comments to the predetermined rule set.

9. The method of claim 6 wherein processing the evaluation comments comprises:
access a database of predetermined feedback content, using an evaluation comment, to identify a set of applicable feedback items; and
select one or more of the identified feedback items for presentation to the student, based on the student's learning style and past performance history.

10. The method of claim 6 wherein the particular subject comprises an improvised explosive device.

11. A non-transitory computer readable storage medium storing software instructions for execution by a processor of a computer, the software instructions implementing a method of computer-assisted training of interview-based information gathering and assessment, the system comprising:
defining a training scenario including a scene defining a physical context of the scenario; a set of one or more witnesses who may be interviewed to obtain clues as to a particular subject of the training scenario; and instructional content defining subject matter to be learned by the student;
presenting information of the training scenario to a student using a Graphical User Interface (GUI);
processing student input using an evaluation engine to generate evaluation comments;
processing the evaluation comments to generate student feedback; and
presenting the student feedback to the student via the GUI;
wherein the predetermined instructional content comprises any one or more of:
a predetermined line of questions to be posed by the student to elicit clues relevant to the particular subject of the training scenario,
preferred questioning techniques to be employed by the student; and
a predetermined line of reasoning to be employed by the student to deduce characteristics of the particular subject.
